(19) United States
(12) Patent Application Publication
(10) Pub. No.: US 2024/0178388 A1
(43) Pub. Date: May 30, 2024

(54) POSITIVE ELECTRODE AND LITHIUM-SULFUR BATTERY COMPRISING THE SAME

(71) Applicant: LG ENERGY SOLUTION, LTD., Seoul (KR)

(72) Inventors: Da-Young KANG, Daejeon (KR); Min-Su KIM, Daejeon (KR); Bong-Soo KIM, Daejeon (KR); Seung-Bo YANG, Daejeon (KR)

(21) Appl. No.: 18/244,128

(22) Filed: Sep. 8, 2023

(30) Foreign Application Priority Data
Nov. 25, 2022 (KR) 10-2022-0159965
Dec. 23, 2022 (KR) 10-2022-0183586
Dec. 23, 2022 (KR) 10-2022-0183771
Dec. 27, 2022 (KR) 10-2022-0185613
May 16, 2023 (KR) 10-2023-0063394
May 31, 2023 (KR) 10-2023-0070299
Jun. 7, 2023 (KR) 10-2023-0073163
Jun. 13, 2023 (KR) 10-2023-0075765

(51) Int. Cl. H01M 4/58; H01M 4/133; H01M 4/136; H01M 4/36; H01M 4/583; H01M 4/62; H01M 10/052

(52) U.S. Cl. CPC H01M 4/5815; H01M 4/133; H01M 4/136; H01M 4/366; H01M 4/583; H01M 4/622; H01M 10/052; H01M 2004/028

(57) ABSTRACT

A positive electrode according to the present disclosure includes a current collector; and a positive electrode active material layer on at least one surface of the current collector, wherein the positive electrode active material layer comprises a sulfur-carbon composite and a binder polymer, wherein the sulfur-carbon composite comprises a porous carbon material and a sulfur-based material disposed on at least a portion of an inside of pores and a surface of the porous carbon material, and wherein a ratio of a thickness of the positive electrode (μm) to an amount of carbon per a unit area (1 cm×1 cm) in the positive electrode active material layer (mg) is 80 to 130 (μm/mg).

### CROSS-REFERENCE TO RELATED APPLICATIONS

This application claims the benefit of and priority to Korean Patent Application No. 10-2022-0159965, filed on Nov. 25, 2022, Korean Patent Application No. 10-2022-0183586, filed on Dec. 23, 2022, Korean Patent Application No. 10-2022-0183771, filed on Dec. 23, 2022, Korean Patent Application No. 10-2022-0185613, filed on Dec. 27, 2022, Korean Patent Application No. 10-2023-0063394, filed on May 16, 2023, Korean Patent Application No. 10-2023-0070299, filed on May 31, 2023, Korean Patent Application No. 10-2023-0073163, filed on Jun. 7, 2023, and Korean Patent Application No. 10-2023-0075765, filed on Jun. 13, 2023, the disclosures of which are incorporated herein by reference in their entirety.

### TECHNICAL FIELD

The present disclosure relates to a lithium-sulfur battery with high energy density.

### BACKGROUND

As energy storage technology has been receiving increasing attention, its range of applications has extended to various devices, including mobile phones, tablets, laptops, camcorders, electric vehicles (EVs), and hybrid electric vehicles (HEVs). Consequently, research and development of electrochemical devices are gradually increasing. In this aspect, electrochemical devices, particularly secondary batteries including lithium-sulfur batteries capable of charge/discharge, are gaining significant attention. Recently, there have been efforts in the development of batteries to enhance capacity density and specific energy through new design of electrodes and batteries.

Among electrochemical devices, lithium-sulfur (LiS) batteries are attracting attention as next-generation secondary batteries that can potentially replace lithium-ion batteries due to their high energy density. In these batteries, lithium-sulfur is used as the positive electrode active materials. During discharging, the reduction reaction of sulfur and the oxidation reaction of lithium metal occur. In this process, sulfur forms lithium polysulfide (Li₂S₂, Li₂S₄, Li₂S₆, Li₂S₈) of a linear structure from S₈ of a ring structure, and lithium-sulfur batteries exhibit a gradual discharge voltage until the polysulfides (PS) are completely reduced to Li—S.

In lithium-sulfur batteries, using carbon materials with a high specific surface area and high porosity, such as, carbon nanotubes, as sulfur hosts, can lead to achieving high energy density and desirable life characteristics. However, additional research is needed to achieve adequate energy density and life characteristics for commercialization.

Attempts have been made to increase the loading of the positive electrode active material, sulfur, in order to increase the energy density. However, as sulfur is non-conductive, increasing the sulfur content results in reduced reactivity and energy density.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure is directed to providing a lithium-sulfur battery with high loading and high energy density.

It will be easily understood that these and other objectives and advantages of the present disclosure may be realized by means or methods set forth in the appended claims and a combination thereof.

To solve the above-described problem, according to an aspect of the present disclosure, there is provided a positive electrode of the following embodiments.

The positive electrode according to a first embodiment comprises a current collector; and a positive electrode active material layer on at least one surface of the current collector, wherein the positive electrode active material layer comprises a sulfur-carbon composite and a binder polymer, wherein the sulfur-carbon composite comprises a porous carbon material and a sulfur-based material disposed on at least a portion of an inside of pores and a surface of the porous carbon material, and wherein a ratio of a thickness of the positive electrode active material layer (μm) to an amount of carbon per unit area (1 cm²) in the positive electrode active material layer (mg) is 80 to 130 μm/mg.

According to a second embodiment, in the first embodiment, an amount of sulfur (S) may be 65 wt % or more and less than 100 wt % based on 100 wt % of the positive electrode active material layer.

According to a third embodiment, in the first or second embodiment, a porosity of the positive electrode active material layer may be 80 vol % or more.

According to a fourth embodiment, in any one of the first to third embodiments, a tap density of the porous carbon material may be 0.09 g/cm³ or less, and wherein the tap density is measured after tapping a vessel containing the porous carbon material 1000 times.

According to a fifth embodiment, in any one of the first to fourth embodiments, the porous carbon material may have a particle shape uniformity according to Equation 1 of 1.3 or less:

Particle shape uniformity=[an average diameter of a circumscribed circle of particles]/[an average diameter of an inscribed circle of the particles]. [Equation 1]

According to a sixth embodiment, in any one of the first to fifth embodiments, a sulfur loading amount of the positive electrode may be more than 2.9 mgs/cm².

According to a seventh embodiment, in any one of the first to sixth embodiments, the porous carbon material may comprise bundled carbon nanotubes or entangled carbon nanotubes.

According to an eighth embodiment, in the fourth embodiment, the tap density of the porous carbon material may be 0.07 g/cm³ or less.

According to a ninth embodiment, in any one of the first to eighth embodiments, the porous carbon material may be a product from which a raw material porous carbon material is centrifugally milled and filtered through a sieve having a mesh size 2.8 to 4 times of a D₅₀ particle size of the porous carbon material.

According to another aspect of the present disclosure, there is provided a lithium-sulfur battery of the following embodiments.

The lithium-sulfur battery according to a tenth embodiment comprises the positive electrode according to any one of the first to ninth embodiments; a negative electrode; and a separator between the positive electrode and the negative electrode; and an electrolyte.

According to an eleventh embodiment, in the tenth embodiment, a weight ratio (El/S weight ratio) of the electrolyte and sulfur (S) in the sulfur-carbon composite may be 3.5 g/g or less.

According to a twelfth embodiment, in any one of the tenth and eleventh embodiments, the lithium-sulfur battery may have an energy density of 400 Wh/kg or more.

According to a thirteenth embodiment, in any one of the tenth to twelfth embodiments, the thickness of the positive electrode active material layer (μm) and the amount of carbon per unit area in the positive electrode active material layer (mg) may be values measured when a state of charge (SOC) of the lithium-sulfur battery is 97% to 100%.

According to a fourteenth embodiment, in any one of the tenth to thirteenth embodiments, the thickness of the positive electrode active material layer (μm) and the amount of carbon per unit area in the positive electrode active material layer (mg) may be values measured after at least one discharge of the lithium-sulfur battery.

According to a fifteenth embodiment, in any one of the tenth to fourteenth embodiments, an amount of the sulfur (S) may be 65 wt % or more and less than 100 wt % based on 100 wt % of the positive electrode active material layer.

According to a sixteenth embodiment, in any one of the tenth to fifteenth embodiments, a porosity of the positive electrode active material layer may be 80 vol % or more.

According to a seventeenth embodiment, in any one of the tenth to sixteenth embodiments, a tap density of the porous carbon material may be 0.09 g/cm³ or less, wherein the tap density is measured after tapping a vessel containing the porous carbon material 1000 times.

According to an eighteenth embodiment, in the fifteenth embodiment, the porous carbon material may have a particle shape uniformity according to Equation 1 of 1.3 or less:

Particle shape uniformity=[an average diameter of a circumscribed circle of particles]/[an average diameter of an inscribed circle of the particles]. [Equation 1]

According to a nineteenth embodiment, in any one of the tenth to eighteenth embodiments, the porosity of the positive electrode active material layer may be 81 vol % to 85 vol %.

According to a twentieth embodiment, in any one of the tenth to nineteenth embodiments, the porous carbon material may comprise bundled carbon nanotubes or entangled carbon nanotubes.

According to an aspect of the present disclosure, it may be possible to provide the positive electrode for the lithium-sulfur battery with high loading of the positive electrode active material, sulfur, and the lithium-sulfur battery comprising the same. In particular, according to the present disclosure, it may be possible to provide the lithium-sulfur battery with high loading of the positive electrode active material, sulfur, and improved energy density by maintaining and improving electrochemical reactivity of sulfur.

### BRIEF DESCRIPTION OF DRAWINGS

FIG. 1 is a specific capacity evaluation graph of lithium-sulfur batteries according to Comparative Examples 1, 2 and 4 in the present disclosure.

FIG. 2 is a specific capacity evaluation graph of lithium-sulfur batteries according to Comparative Example 1 and Examples 1 and 2 in the present disclosure.

FIG. 3 is a graph showing the relative energy density of lithium-sulfur batteries according to Examples 1 and 2 and Comparative Examples 1 to 3.

FIG. 4A is a SEM image of the porous carbon material used to measure the particle shape uniformity of the porous carbon material in Comparative Example 4 in the present disclosure. Crossed arrows on the image represent diameters of the circumscribed circle and the inscribed circle of the particle, respectively.

FIG. 4B is a SEM image of the porous carbon material used to measure the particle shape uniformity of the porous carbon material used in Example 1 in the present disclosure. Crossed arrows on the image represent diameters of the circumscribed circle and the inscribed circle of the particle, respectively.

FIG. 5 is a SEM image (left) showing that the surface of the porous carbon material of Comparative Example 1 is relatively flat and a SEM image (right) showing that the surface of the porous carbon material of Example 1 is relatively rough.

### DETAILED DESCRIPTION

Hereinafter, the present disclosure will be described in detail.

The term “include”, “comprise” or “have” when used in this specification, specifies the presence of stated elements, but does not preclude the presence or addition of one or more other elements, unless the context clearly indicates otherwise.

Additionally, the terms “about” and “substantially” as used herein are used in the sense of at, or nearly at, when given the manufacturing and material tolerances inherent in the stated circumstances, and are used to prevent the unscrupulous infringer from unfairly taking advantage of the present disclosure where exact or absolute figures are stated as an aid to understanding the present disclosure.

Throughout the specification, “A and/or B” refers to either A or B or both.

The term “composite” as used herein refers to a material with physically⋅chemically different phases and more effective functions, formed by combining two or more materials.

The term “polysulfide” as used herein is the concept that covers “polysulfide ion (Sx²⁻, 1≤x≤8)” and “lithium polysulfide (Li₂Sₓ or LiSₓ⁻, 1≤x≤8)”.

In the present disclosure, “specific surface area” is measured by the Brunauer, Emmett and Teller (BET) method, and specifically, it may be calculated from the adsorption amount of nitrogen gas under the liquid nitrogen temperature (77K) using BEL Japan's BELSORP-mini II.

In the present disclosure, “particle size D₁₀” refers to a particle size at 10% of cumulative volume particle size distribution of particles, “particle size D₅₀” refers to a particle size at 50% of cumulative volume particle size distribution of particles, and “particle size D₉₀” refers to a particle size at 90% of cumulative volume particle size distribution of particles.

Each of the particle size D₁₀, D₅₀ and D₉₀ may be measured using a laser diffraction method. For example, each of the particle size D₁₀, D₅₀ and D₉₀ may be measured by dispersing a target particle powder in a dispersion medium, introducing into a commercially available laser diffraction particle size measurement apparatus (for example, Microtrac MT 3000), irradiating ultrasound of about 28 kHz with an output of 60 W to acquire a cumulative volume particle size distribution graph, and determining the particle size corresponding to each of 10%, 50% and 90% of the cumulative volume distribution. That is, for example, the particle size D₅₀ represents the median value or median diameter in the particle size distribution graph, and it indicates the particle size at the 50% point on the cumulative distribution. Diameter represents the size of particles and particle diameter refers to the longest length within a particle.

The term “porosity” as used herein refers to a fraction of voids in a structure over the total volume and is indicated in vol %, and may be used interchangeably with void fraction, degree of porosity or the like. The porosity can be measured according to the method known in the art, e.g., specified in ISO 15901:2019.

The present disclosure provides a positive electrode for use in an electrochemical device and an electrochemical device comprising the same. In the present disclosure, the electrochemical device may include any device that causes electrochemical reaction. Specific examples may include any type of primary battery, secondary battery, fuel cell, solar cell or capacitor such as super capacitor. In particular, the electrochemical device may be a secondary battery, and the secondary battery may be a lithium ion secondary battery. The lithium ion secondary battery may include, for example, a lithium-metal battery, a lithium-sulfur battery, an all solid state battery, a lithium polymer battery or the like, and preferably a lithium-sulfur battery.

It is known that the conventional lithium-sulfur batteries have a low energy density disadvantage. To address the disadvantage, carbon materials having high specific surface area and porosity, for example, carbon nanotubes have been used as hosts for sulfur-based materials to achieve relatively high energy density and life characteristics, but commercialization is still challenging. Additionally, it is necessary to increase the loading of the sulfur-based materials in sulfur-carbon composites included in the positive electrode to increase the energy density of the lithium-sulfur batteries, but since the sulfur-based materials have no or little conductivity, the higher loading, the lower reactivity of the positive electrode.

According to an aspect of the present disclosure, there are provided a positive electrode in which sulfur (S₈) is loaded onto a shape modified porous carbon material to increase sulfur loading and electrical conductivity in the positive electrode, thereby improving electrical conductivity, and a lithium-sulfur battery with improved energy density.

The positive electrode according to an aspect of the present disclosure comprises a current collector; and a positive electrode active material layer on at least one surface of the current collector.

Specifically, the positive electrode active material layer comprises a sulfur-carbon composite and a binder polymer, and the sulfur-carbon composite comprises a porous carbon material, and a sulfur-based material disposed on at least a portion of an inside of pores and a surface of the porous carbon material. In one embodiment of the present disclosure, the porous carbon material has a shape of a particle. The porous carbon material may include irregular pores within the interior (closed pores) and/or on the surface (open pores) of the particles. In this case, the average diameter of these pores can range from 1 to 200 nm, for example, and the porosity can be between 10 to 90 vol % of the total volume of the porous carbon material. The average diameter of these pores can be measured, for example, using methods such as gas adsorption-based BET measurement or mercury intrusion porosimetry as known in the art.

The present disclosure is characterized in that the porous carbon material has a specific range of particle sizes.

For example, in an embodiment of the present disclosure, the sulfur-carbon composite may comprise the porous carbon material and the sulfur-based material, and the sulfur-based material is loaded and/or coated on all or at least a portion of the inside of the pores and a surface of the porous carbon material.

In one embodiment of the present disclosure, the positive electrode includes a porous carbon material for supporting a positive electrode active material, and has a small tap density, and thus, has a high porosity. In particular, by supporting the positive electrode active material on the above-described porous carbon material, even when a high content of the active material is included, a passage for movement of substances such as ions in the cathode is sufficiently secured, so that resistance is lowered and capacity is improved.

Specifically, in this instance, the ratio of the thickness of the positive electrode active material layer (μm) to the amount of carbon per unit area (1 cm×1 cm) in the positive electrode active material layer (mg) is 80 to 130 (μm/mg).

The present disclosure implements the ratio of the thickness of the positive electrode active material layer to the carbon weight per unit area of the positive electrode active material layer in a specific range, thereby can increase the content of the active material (i.e., sulfur-based material) and the porosity of the positive electrode active material layer, while improving the reactivity.

As described above, in the positive electrode according to one aspect of the present disclosure, the ratio of the thickness of the positive electrode active material layer to the carbon weight per unit area of the positive electrode active material layer is 80 to 130 μm/mg. Here, the ‘unit area’ means 1 cm² (1 cm×1 cm).

In one embodiment of the present disclosure, the ratio of the thickness of the positive active material layer to the weight of carbon per unit area of the positive active material layer can be calculated by measuring the weight of carbon per 1 cm² of the positive electrode active material layer, and the thickness of the positive electrode active material layer.

In another embodiment of the present disclosure, the carbon weight per unit area of the positive electrode active material layer and the thickness of the positive electrode active material layer may be measured based on an unused fresh cell, respectively, immediately after the positive electrode is manufactured without being used for an electrochemical reaction. Alternatively, the carbon weight per unit area of the positive electrode active material layer and the thickness of the cathode active material layer may be measured after at least one discharge of the cell is performed, respectively. In this case, it is preferable that the electrode has a capacity retention rate of 97% or more of the initial capacity, but the present disclosure is not limited thereto.

Specifically, it may be preferable to measure the thickness of the positive electrode active material layer in a charged state in terms of measurement accuracy. For example, it may be measured based on when it is charged after discharging at least once and has an SOC of 97% or higher, for example, an SOC of 97% to 100%, and specifically, a SOC of 100%. Alternatively, the carbon weight per unit area of the positive electrode active material layer and the thickness of the positive electrode active material layer may be measured based on a cycle when the thickness of the positive electrode active material layer is the thinnest.

In another embodiment of the present disclosure, the ratio of the thickness of the positive electrode active material layer to the weight of carbon per unit area of the positive electrode active material layer is calculated by calculating the weight of carbon per electrode loading and measuring the thickness of the positive electrode active material layer. Here, the electrode loading can be calculated from the content of sulfur (S) in the positive electrode according to a known method.

In another embodiment of the present disclosure, the ratio of the thickness of the positive electrode active material layer to the carbon weight per unit area of the positive electrode active material layer can be calculated by directly analyzing the carbon content per unit area of the positive electrode active material layer and measuring the thickness of the positive electrode active material layer. Here, the method of directly analyzing the carbon content per unit area may include, for example, known elemental analysis methods such as ICP-OES analysis, EA analysis, and ICP analysis, but the measurement method is not limited thereto. In addition, the method of measuring the thickness of the positive electrode active material layer may include a method of measuring the thickness of the entire positive electrode using a known thickness meter, for example, a thickness meter of Mitutoyo Co., and subtracting the thickness of the current collector to determine the thickness of the positive electrode active material layer, but the measuring method is not limited thereto.

In one embodiment of the present disclosure, the carbon weight per unit area of the positive electrode active material layer includes the weight of the carbon derived from the sulfur-carbon composite included in the positive electrode active material layer, as well as the weight of total carbon derived from the binder and/or conductive material that may be included.

Therefore, in one embodiment of the present disclosure, when the composition of the positive electrode and the content of the sulfur-based material in the sulfur-carbon composite are known, the carbon weight per unit area of the positive electrode active material layer can be calculated from the loading amount.

Meanwhile, in a lithium-sulfur battery, the thickness of the positive electrode may be variable according to repeated charge/discharge cycles of the battery. Therefore, in order to measure the ratio of the thickness of the positive electrode active material layer to the carbon weight per unit area of the positive active material layer, conditions for the number of charge/discharge cycles and/or state of charge (SOC) may be required. During discharge of the battery, discharge products are generated inside the structure of the porous carbon material in the positive electrode active material layer, and thus it may be difficult to accurately measure the thickness of the positive electrode active material layer without excluding the discharge products. Accordingly, the thickness of the positive electrode active material layer may be measured based on a state of charge, for example, when the SOC is 97% to 100%, preferably when the SOC is 100%.

As described above, the positive electrode in which the ratio of the thickness of the positive electrode active material layer to the carbon weight per unit area of the positive electrode active material layer satisfies 80 to 130 μm/mg, for example, may have a content of sulfur (S) of 65 wt % or more and 100 wt % or less, based on 100 wt % of the total positive electrode active material layer and the porosity may be 80 vol % or more.

In one embodiment of the present disclosure, the ratio of the thickness of the positive electrode active material layer to the carbon weight per unit area of the positive electrode active material layer is, for example, 80 to 120 μm/mg, 80 to 110 μm/mg, 80 to 100 μm/mg or 83 to 98 μm/mg. In addition, the ratio of the thickness of the positive electrode active material layer to the carbon weight per unit area of the positive electrode active material layer based on the electrode immediately after manufacture (fresh cell) may be, for example, 90 to 120 μm/mg or 95 to 119 μm/mg.

In addition, the present disclosure is characterized in that the amount of sulfur (S) may be 65 wt % or more and less than 100 wt % based on the total 100 wt % of the positive electrode active material layer, and the porosity of the positive electrode active material layer may be 80 vol % or more.

That is, according to an aspect of the present disclosure, the use of the shape modified porous carbon material may increase the sulfur loading in the positive electrode active material and ensure the porosity of the positive electrode active material layer.

In the conventional lithium-sulfur batteries, when a very large amount of sulfur-based material is included in the positive electrode active material layer, the reactivity of the positive electrode decreases, so it was difficult to include the sulfur-based material in an amount of 60 wt % or more based on the total 100 wt % of the positive electrode active material layer.

Specifically, the positive electrode according to an aspect of the present disclosure may comprise 65 wt % or more and less than 100 wt % of the sulfur-based material based on the total 100 wt % of the positive electrode active material layer and have the porosity of 80 vol % or more in the positive electrode active material layer.

In an embodiment of the present disclosure, the sulfur-based material may include, without limitation, any material that provides sulfur (S₈) as the active material of the lithium-sulfur battery. For example, the sulfur-based material comprises at least one of sulfur (S₈) or a sulfur compound.

In an embodiment of the present disclosure, the sulfur-based material may comprise at least one selected from the group consisting of inorganic sulfur (S₈), Li₂Sₙ (n≥1), an organic sulfur compound including at least one of 2,5-dimercapto-1,3,4-thiadiazole or 1,3,5-trithiocyanuic acid; and a carbon-sulfur polymer ((C₂Sₓ)ₙ, x is 2.5 to 50, n≥2). In an embodiment of the present disclosure, the sulfur-based material may be included in the sulfur-carbon composite by physical adsorption with the porous carbon material, or chemical bond such as covalent bond or Van der Waals bond between sulfur (S) and carbon in the porous carbon material.

In the sulfur-carbon composite according to the present disclosure, the sulfur-based material may be present in at least one of the inside of the pores of the carbon material or the surface of the carbon material, and in this instance, may be present in an area of less than 100% of the inside of the pores and the surface of the carbon material, preferably 1 to 95%, and more preferably 60 to 90%. When sulfur is present on the surface of the porous carbon material within the above-described range, it may be possible to obtain the maximum effect in terms of electron transport area and electrolyte wetting. Specifically, when sulfur is impregnated onto the surface of the porous carbon material uniformly to a small thickness at the area of the above-described range, it may be possible to increase the electron transport contact area during charging⋅discharging. In case that sulfur is present in the area corresponding to 100% of the entire surface of the porous carbon material, the carbon material is completely covered with sulfur, resulting in poor electrolyte wetting and low contact with a conductive material included in the electrode, thereby failing to accept electrons and participate in reaction.

In an embodiment of the present disclosure, the amount of sulfur (S) may be 65 wt % or more, for example 65 to 80 wt %, 65 to 75 wt %, 65 to 70 wt %, or 70 to 75 wt % based on the total 100 wt % of the positive electrode active material layer. For example, the amount of sulfur may be 67.2 to 72 wt % based on the total 100 wt % of the positive electrode active material layer. When the amount of the sulfur is in the above-described range, it may be possible to improve the capacity of the battery using the same and the stability of the battery, but the present disclosure is not limited thereto.

In an embodiment of the present disclosure, the porous carbon material may have shape modification of porous carbon materials used in lithium-sulfur batteries. Specifically, the porous carbon material may have a particle shape, particularly an angular particle shape. For example, the porous carbon material may have a particle shape having prismoidal sphericity.

As will be described later, the porous carbon material may have a modified particle shape by using a centrifugal mill. Referring to FIG. 5, it is confirmed that the surface (left) of the porous carbon material pulverized by a jet mill or the like is relatively flat, whereas the surface (right) of the porous carbon material milled by a centrifugal mill is relatively rough. It is confirmed that the porous carbon material on the right has an angular particle shape due to the rough surface characteristics. In addition, the porous carbon material may comprise any carbon-based material having pores and conductive properties commonly used in the corresponding technical field. For example, the porous carbon material may comprise at least one selected from the group consisting of graphite; graphene; carbon black including DENKA black, acetylene black, Ketjenblack, channel black, furnace black, lamp black, thermal black; carbon nanotubes (CNT) including single-walled carbon nanotubes (SWCNT) and multi-walled carbon nanotubes (MWCNT); carbon fibers including graphite nanofibers (GNF), carbon nanofibers (CNF) and activated carbon fibers (ACF); graphite including natural graphite, artificial graphite and expandable graphite; carbon nanoribbon; carbon nanobelt, carbon nanorod and activated carbon.

In an embodiment of the present disclosure, the porous carbon material may comprise carbon nanotubes. The carbon nanotube is a tube made of carbons connected in hexagonal shape. According to an embodiment of the present disclosure, the carbon nanotubes may be single-walled carbon nanotubes (SWCNT), multi-walled carbon nanotubes (MWCNT) or a combination thereof according to the number of layers of carbon atoms (referred to as ‘carbon walls’) of which the carbon nanotubes are made. Here, the length of the respective carbon nanotube is not particularly limited.

In an embodiment of the present disclosure, the porous carbon material may comprise carbon nanotubes, specifically multi-walled carbon nanotubes (MWCNT) to improve the sulfur loading, but the present disclosure is not limited thereto.

In another embodiment of the present disclosure, the carbon nanotubes may comprise two or more carbon nanotubes entangled in close contact with each other by the cohesive force between them. Specifically, in an embodiment of the present disclosure, the carbon nanotubes may be provided in the form of a carbon nanotube dispersion in which single strands are dispersed in a dispersion medium, or a secondary structure formed by agglomeration of carbon nanotubes of primary structure.

In this aspect, when the porous carbon material comprises carbon nanotubes, the carbon nanotubes may comprise at least one of a bundled secondary structure or an entangled secondary structure.

The bundled secondary structure of the carbon nanotubes refers to an agglomerate of primary structures aligned in the lengthwise direction of carbon nanotubes and bonded by the cohesive force between carbons, each primary structure being a single strand of carbon nanotube, and may be referred to as bundled CNT.

In an embodiment of the present disclosure, the carbon nanotubes may comprise, for example, entangled multi-walled carbon nanotubes.

In an embodiment of the present disclosure, the porous carbon material may have, for example, the BET specific surface area of 150 m²/g or more. 17 mp example, 150 to 2500 m²/g, 150 to 2,000 m²/g, 150 to 1,500 m²/g, 150 to 1,000 m²/g, 130 to 300 m²/g, or 170 to 200 m²/g, but is not limited thereto. In the present disclosure, the “specific surface area” is measured by the Brunauer, Emmett and Teller (BET) method, and specifically, it may be calculated from the adsorption amount of nitrogen gas under the liquid nitrogen temperature (77K) using BEL Japan's BELSORP-mini II.

In an embodiment of the present disclosure, the porous carbon material may comprise a secondary structure formed by agglomeration of primary structures of carbon nanotubes.

According to an embodiment of the present disclosure, the porous carbon material may be subjected to shape modification by grinding. Specifically, the grinding may involves crushing or shearing of particles. For example, the particles may be crushed or sheared between two blades. In this instance, the grinding is used to crush or shear the particles by applying stimulation to the outer surface of the particles. Additionally, when grinding the particles, the particles may be broken or separated by the friction between the rotating blades of a grinder and the particles.

In general, carbon nanotubes, such as single-walled carbon nanotubes (SWCNT) or multi-walled carbon nanotubes (MWCNT), are synthesized using a thermal chemical vapor deposition method or an arc discharge method, and agglomeration occurs between the respective carbon nanotubes particles in the synthesis process. The agglomeration of the carbon nanotubes may be classified into physical agglomeration which is entangled agglomeration of nanotubes as each particle with each other at μm level, and chemical agglomeration which is agglomeration by surface attraction (˜950 meV/nm) such as the van der waals force or the force between molecules at nm (nanometer) level like single-walled carbon nanotubes (SWCNT). The agglomeration of the carbon nanotubes may hinder the formation of a 3-dimensional network structure that may improve the mechanical strength and electrical conductivity characteristics. Agglomeration is a common phenomenon appearing in a linear conductive carbon material such as carbon nanotubes. In this context, the present disclosure uses the linear conductive carbon material to manufacture the electrode after disintegration by preprocessing, for example, grinding, and thus the below-described predetermined tap density range may be satisfied and the filling ratio of the sulfur-based material may be improved.

The porous carbon material of the conventional lithium-sulfur battery was used after it was preprocessed by a jet mill. However, the preprocessing of the porous carbon material through the jet mill falls short of improving the tap density due to the low particle shape uniformity of the porous carbon material and its smooth particle surface. However, the present disclosure can use a grinder to preprocess the porous carbon material. Since defects or flaws (for example, tearing) are generated in the respective conductive carbon materials on the surface of the porous carbon material and the conductive carbon materials are separated or loosened, it may be possible to increase the particle shape uniformity of the porous carbon material and improve the surface roughness of the particles. This, in turn, can further increase the sulfur loading and improve the tap density. However, the present disclosure is not limited thereto.

In an embodiment of the present disclosure, the preprocessing for the shape modification of the porous carbon material may further include a process of sieving using a sieve of a predetermined size after the grinding. In one embodiment of the present disclosure, the porous carbon material may be prepared by a pre-treatment process including milling by a centrifugal mill and filtering using a sieve according to the particle size, so that the porous carbon material has the above-described particle size. For example, the pre-treatment process includes:
(1) a step of centrifugally milling a porous carbon material; and
(2) a step of filtering the centrifugally milled porous carbon material through a sieve,
wherein a mesh size of the sieve is 2.8 to 4 times of a target particle size D₅₀ of the porous carbon material. The mesh size may be 50 μm to 100 μm.

Conventionally, the porous carbon material has been pulverized using a ball mill, a blade, etc. in order to control the particle size of the porous carbon material. However, the conventional pulverization method has the problem that a porous carbon material with a large particle size and a porous carbon material with a small particle size exist together as the porous carbon material contacts with the ball or the blade randomly, resulting in a broad particle size distribution.

In one embodiment of the present disclosure, in the above-described pre-treatment method, the step (1) may be performed by utilizing a centrifugal mill including the sieve and a plurality of rotating teeth, and in the step (1), the porous carbon material is milled by contacting the plurality of rotating teeth in the centrifugal mill. The rotating teeth may have an angular velocity of 30 to 125 rad/s. Preferably, the rotating teeth can have an angular velocity of 30 to 95 rad/s. When the centrifugal milling speed in step (1) is within the aforementioned range, it can be advantageous in terms of finely and uniformly controlling the particle size of the porous carbon material while not increasing tap density.

The centrifugal mill, for example, may include 2 to 20, 4 to 18, 6 to 16, 8 to 14, 10 to 14, or 10 to 12 rotating teeth. Furthermore, in one embodiment of the present disclosure, each of the plurality of the rotating teeth can have a shape of a triangular prism. The plurality of rotating teeth can be arranged to face the rotation axis of the centrifugal mill. Specifically, when viewed from the top of the centrifugal mill, the plurality of rotating teeth can be arranged such that an edge of each of the triangular prisms faces the center of the centrifugal mill.

In one embodiment of the present disclosure, the plurality of rotating teeth can be made of materials such as stainless steel, titanium, or stainless steel with protective coatings. However, this is not limited thereto.

The centrifugal milling may be performed at 6,000-23,000 rpm for the control of the particle size of the porous carbon material. For example, centrifugal milling can be performed using Retsch ZM 200 device at speeds ranging from 6,000 to 23,000 rpm, preferably at speeds of 6,000 to 18,000 rpm.

In one embodiment of the present disclosure, considering that the force applied can vary with the size of the centrifugal mill even at the same RPM, it's possible to adjust the RPM to achieve grinding at angular velocities between 30 and 125 rad/s according to the formula below, taking into account the size of the centrifugal grinder:

Angular Velocity (rad/s)=(RPM×Circumference)/60 seconds

In the formula above, ‘Circumference’ represents the distance traveled during one rotation of a rotating tooth.

In the above-described pre-treatment method, the step (2) is a step in which the porous carbon material centrifugally milled in the step (1) is filtered through a sieve.

The sieve may be equipped on an outer rim of the centrifugal mill. Specifically, the sieve can be equipped to surround the plurality of rotating teeth within the centrifugal mill. In one embodiment of the present disclosure, the sieve can have a cylindrical shape and be arranged around the plurality of rotating teeth. For example, from the top view of the centrifugal mill, the shortest distance between the plurality of rotating teeth and the sieve can be 0.1 to 5 mm or 0.5 to 2 mm, such as 1 mm. The sieve can include a mesh with trapezoidal and/or circular holes.

In one embodiment of the present disclosure, as the teeth rotate, the porous carbon material is milled by contacting the rotating teeth and the porous carbon material with controlled particle sizes can pass the sieve immediately while a centrifugal force is applied. Therefore, the issues of further reducing particle size and/or damaging the surface can be prevented. According to one aspect of the present disclosure, performing steps (1) and (2) simultaneously can achieve controlled particle diameter and obtain porous carbon material with a narrow particle size distribution.

In this manner, in one embodiment of the present disclosure, it may be advantageous for step (2) to be performed with centrifugal force applied to the porous carbon material.

In the step (2), the porous carbon material centrifugally milled in the step (1) is transferred to and filtered through a sieve. The steps (1) and (2) may be performed by a continuous process.

The particle size of the porous carbon material may be controlled by controlling the mesh size of the sieve used in the step (2). The mesh size of the sieve may be 2.8-4 times of the target particle size D₅₀ of the porous carbon material, i.e., the particle size D₅₀ of the porous carbon material filtered through the sieve in the step (2) (2.8≤mesh size/target D₅₀≤4). When the mesh size of the sieve is limited as described above, the desired D₅₀ particle size of the porous carbon material may be achieved and a porous carbon material with a narrow particle size distribution may be obtained.

In one embodiment of the present disclosure, the target particle size D₅₀ of the porous carbon material can be, for example, the particle size D₅₀ of the porous carbon material manufactured according to one aspect of the present disclosure. For example, it can range from 10 μm to 100 μm, 5 μm to 90 μm, 10 μm to 80 μm, 15 μm to 70 μm, 20 μm to 60 μm, 10 μm to 50 μm, 15 μm to 40 m, or 20 μm to 40 μm.

In the lithium-sulfur battery according to an embodiment of the present disclosure, the porous carbon material preferably has, for example, the tap density of 0.1 g/cm³ or less, or less than 0.1 g/cm³ when measured after tapping a vessel containing the porous carbon material 1000 times. For example, in an embodiment of the present disclosure, the tap density of the porous carbon material may be 0.09 g/cm³ or less. Specifically, the tap density of the porous carbon material may be 0.07 g/cm³ or less. More specifically, the tap density of the porous carbon material may be 0.02 g/cm³ to 0.09 g/cm³, 0.05 g/cm³ to 0.09 g/cm³, or 0.05 g/cm³ to 0.07 g/cm³. When the tap density of the porous carbon material is in the above-described range, it may be possible to increase the amount of the sulfur-based material loaded onto the porous carbon material, improve the porosity of the positive electrode active material layer, and provide the lithium-sulfur battery with high energy density and high reactivity of the positive electrode, but the present disclosure is not limited thereto.

In the present disclosure, the tap density may be measured in accordance with ASTM B527-06, and may be measured using TAP-2S (LOGAN).

According to an embodiment of the present disclosure, the shape modified porous carbon material may comprise spherical particles having pores on the surface in which a ratio of long axis length and short axis length of the sphere is 1.3 or less. For example, the length ratio of long axis and short axis of the porous carbon material according to the following Equation 1 may be 1 to 1.3, 1 to 1.2, or 1 to 1.1.

Particle shape uniformity=[an average diameter of a circumscribed circle of particles]/[an average diameter of an inscribed circle of the particles]. [Equation 1]

In the present disclosure, the particle shape uniformity may be expressed as a ratio of long axis length and short axis length of the particle, i.e., a length ratio of the diameter of the circumscribed circle of the particle and the diameter of the inscribed circle of the particle, and in this instance, as the uniformity is higher, the value may be closer to “1”, and as the uniformity is lower, the value may be farther away from 1.

In an embodiment of the present disclosure, the ‘long axis’ may represent the longest length of the particle, and preferably, may be measured as the length of the diameter of the circumscribed circle of the particle. Additionally, the ‘short axis’ may represent the shortest length of the particle, and preferably, may be measured as the length of the diameter of the inscribed circle of the particle.

In the present disclosure, the length of the long axis (the diameter of the circumscribed circle) of the particle and the length of the short axis (the diameter of the inscribed circle) may be measured for each particle using an image analyzer, for example, scanning electron microscopy (SEM), transmission electron microscopy (TEM), or measured by the known particle size measurement methods.

In an embodiment of the present disclosure, the particle shape uniformity may be measured by imaging a sheet of particles distributed and immobilized in parallel arrangement using a scanning electron microscope (S-4800, Hitachi High-Technologies Corporation) immediately above the sheet, and analyzing the image using Azokun (Asahi Kasei Engineering Corporation). In this instance, particle shape uniformity of minimum 5 particles, for example, 10 to 1,000 particles, 100 to 1000 particles, 10 to 500 particles, or 100 to 500 particles, or just 5 or 10 particles may be measured, and the average of the measured particle shape uniformity values may be used as the particle shape uniformity of particles. For example, shape uniformity of 300 particles may be measured, and the average value of the measured particle shape uniformity values may be the shape uniformity of all the particles. However, the number of particles used to measure the particle shape uniformity is not limited to the above-described range, and those skilled in the art may select the proper number of particles.

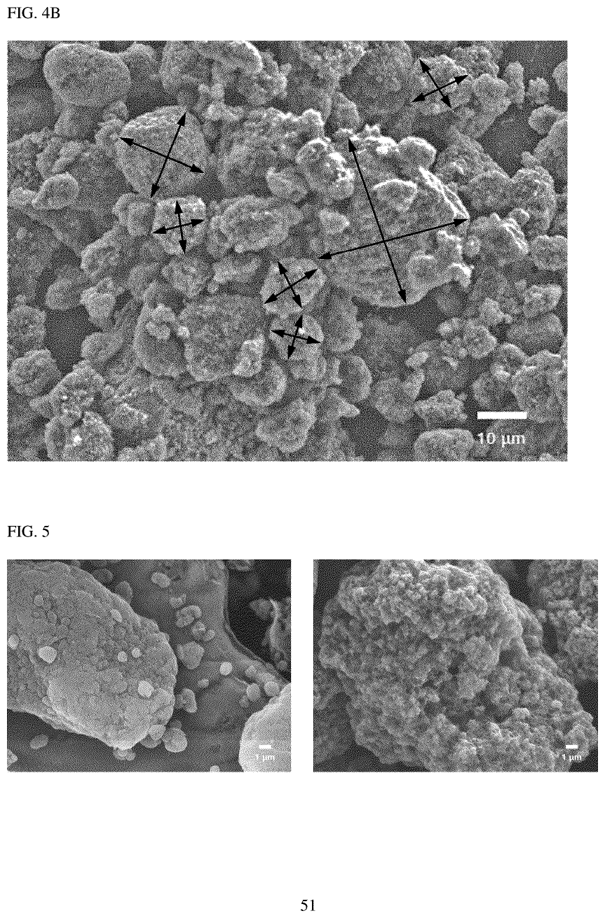

FIGS. 4A and 4B show SEM images (Jeol Inc, 1,000 magnification) used to measure the particle shape uniformity of the porous carbon material according to an embodiment of the present disclosure. According to one embodiment of the present disclosure, the particle shape uniformity may be calculated by measuring the length ratio of the long axis and the short axis of at least 5 particles on the image of the porous carbon material and calculating an average value thereof.

In an embodiment of the present disclosure, the particle size D₅₀ of the shape modified porous carbon material may be, for example, 120 μm or less, for example, 100 μm or less, 90 μm or less, or 80 μm or less. When the particle size of the porous carbon material satisfies the above-described range, the electrode surface uniformity may increase, and the cycling life of the battery may improve.

In another embodiment of the present disclosure, the shape modified porous carbon material may have a Broadness Factor (BF) of 7 or less. The broadness factor (BF) as described in this present disclosure is defined in Equation 2:

Broadness factor (BF)=(particle size D₉₀ of the porous carbon material)/(particle size D₁₀ of the porous carbon material)] [Equation 2]

In the present disclosure the “particle size D₁₀” refers to a particle size at 10% of cumulative volume particle size distribution of particles, the “particle size D₅₀” refers to a particle size at 50% of cumulative volume particle size distribution of particles, and the “particle size D₉₀” refers to a particle size at 90% of cumulative volume particle size distribution of particles.

Each of D₁₀, D₅₀ and D₉₀ may be measured using a laser diffraction method. For example, each of D₁₀, D₅₀ and D₉₀ may be measured by dispersing a powder of particles to be measured in a dispersion medium, introducing into a commercially available laser diffraction particle size measurement machine (for example, Microtrac MT 3000), irradiating ultrasound of about 28 kHz with an output of 60 W to acquire a cumulative volume particle size distribution graph, and determining the particle size corresponding to each of 10%, 50% and 90% of the cumulative volume distribution.

Using the above-described porous carbon material, the positive electrode active material layer according to an aspect of the present disclosure may have the porosity of 80 vol % or more, but the mechanism of the present disclosure is not limited thereto.

In an embodiment of the present disclosure, the porosity of the positive electrode active material layer may be, for example, 80 vol % to 90 vol %, specifically 80 vol % to 85 vol %, 81 vol % to 85 vol %, or 82 vol % to 83 vol %. When the porosity of the positive electrode active material layer is in the above-described range, it may be possible to improve the reactivity of the positive electrode, but the present disclosure is not limited thereto.

In the present disclosure, the porosity of the positive electrode active material layer may be, for example, measured by the commonly used Hg porosimeter, and for example, may be measured using a mercury porosimeter (Micromeritics AUTOPORE V). Additionally, the porosity of the positive electrode active material layer may be measured by the Brunauer-Emmett-Teller (BET) measurement method using the commonly used adsorption gas such as nitrogen, and for example, may be measured using BEL Japan's BELSORP series analyzer, for example, mini II, but the present disclosure is not limited thereto. The porosity measured by the above-described method may refer to the total volume of pores in the positive electrode. Additionally, the porosity may be measured by calculation from the true density of the constituent materials of the positive electrode active material layer, the apparent density of the manufactured positive electrode active material layer and the thickness of the positive electrode active material layer. Specifically, the porosity may be calculated as a value of [(true density−apparent density)/true density]×100(%) of the positive electrode.

Hereinafter, the configuration of the positive electrode of the present disclosure will be described in more detail.

The sulfur-carbon composite may be formed by simply mixing the sulfur-based material with the carbon material, or coating or loading into a core-shell structure. The coating of the core-shell structure may comprise coating any one of the sulfur-based material and the carbon material on the other material, and for example, covering the surface of the carbon material with sulfur or vice versa. Additionally, the loading may comprise filling the sulfur-based material in the carbon material, especially the pores of the carbon material. The sulfur-carbon composite may be available in any form that satisfies the above-described content ratio of the sulfur and the carbon material, and the present disclosure is not limited thereto.

In an embodiment of the present disclosure, the sulfur-carbon composite preferably comprises the sulfur-based material in an amount of 60 wt % or more or 70 wt % or more based on 100 wt % of the sulfur-carbon composite. For example, the sulfur-carbon composite may preferably comprise the sulfur-based material in an amount of 60 wt % to 99 wt %, 70 wt % to 99 wt %, 75 wt % to 90 wt %, 70 wt % to 85 wt %, 70 wt % to 80 wt %, or 70 wt % to 75 wt % based on 100 wt % of the sulfur-carbon composite.

In one embodiment, the positive electrode may have a loading amount of 3.5 mAh/cm² or more, preferably of 3.5 mAh/cm² or more and 4.5 mAh/cm² or less.

In an embodiment of the present disclosure, in addition with the sulfur-carbon composite, the positive electrode active material layer may comprise a binder polymer. Additionally, in addition to the positive electrode active material and the binder resin, the positive electrode active material layer may further comprise a conductive material, if necessary. In this instance, in an embodiment of the present disclosure, the positive electrode active material layer may preferably comprise the positive electrode active material in an amount of 70 wt % or more, 85 wt % or more, or 90 wt % or more based on 100 wt % of the positive electrode active material layer.

The binder polymer may play a role in attaching the positive electrode active material particles to each other and improving the adhesion strength between the positive electrode active material and the positive electrode current collector, and specific examples may include at least one of polyvinylidenefluoride (PVDF), a vinylidene fluoride-hexafluoropropylene copolymer (PVDF-co-HFP), polyvinylalcohol, polyacrylonitrile, carboxymethyl cellulose (CMC), starch, hydroxypropylcellulose, regenerated cellulose, polyvinylpyrrolidone, polytetrafluoroethylene, polyethylene, polypropylene, ethylene-propylene-diene monomer rubber (EPDM rubber), sulfonated-EPDM, styrene butadiene rubber (SBR), fluoro rubber, or a variety of copolymers thereof. The binder resin may be included in an amount of 1 to 30 wt %, preferably 1 to 20 wt %, and more preferably 1 to 10 wt % based on the total weight of the positive electrode active material layer.

Conductive material may be used to provide conductive properties to the electrode, and may include, without limitation, any conductive material having the ability to conduct electrons without causing any chemical change in the corresponding battery. Specific examples may include at least one of graphites such as natural graphite or artificial graphite; a carbon-based material such as carbon black, acetylene black, Ketjenblack, channel black, furnace black, lamp black, thermal black, carbon fibers, carbon nanotubes; metal powder or metal fibers of copper, nickel, aluminum, silver; conductive whiskers of zinc oxide, potassium titanate; conductive metal oxide such as titanium oxide; or conductive polymer such as polyphenylene derivatives. When the conductive material is used, the conductive material may be typically included in an amount of 1 to 30 wt %, preferably 1 to 20 wt %, and more preferably 1 to 10 wt % based on the total weight of the positive electrode active material layer, but the present disclosure is not limited thereto.

In an embodiment of the present disclosure, the positive electrode current collector may include various types of positive electrode current collectors used in the corresponding technical field. For example, the positive electrode current collector may include stainless steel, aluminum, nickel, titanium, sintered carbon or aluminum or stainless steel treated with carbon, nickel, titanium or silver on the surface. The positive electrode current collector may be typically 3 μm to 500 μm in thickness, and the positive electrode current collector may have microtexture on the surface to increase the adhesion strength of the positive electrode active material. The positive electrode current collector may come in various forms, for example, a film, a sheet, a foil, a net, a porous body, a foam and a nonwoven.

According to another aspect of the present disclosure, there is provided a lithium-sulfur battery comprising the above-described positive electrode.

Specifically, the lithium-sulfur battery comprises an electrode assembly comprising a positive electrode, a negative electrode and a separator interposed between the positive electrode and the negative electrode; and an electrolyte, wherein the positive electrode comprises the above-described sulfur-carbon composite as a positive electrode active material.

For example, the electrode assembly may form a stack type or stack/folding structure including the negative electrode and the positive electrode stacked with the separator interposed between the negative electrode and the positive electrode, or a jelly-roll structure including the negative and positive electrodes and the separator rolled up. Furthermore, in the jelly-roll structure, an additional separator may be placed on the outer side to prevent the contact between the negative electrode and the positive electrode.

The negative electrode may comprise a negative electrode current collector; and a negative electrode active material layer on at least one surface of the negative electrode current collector, and the negative electrode active material layer may comprise a negative electrode active material, and if necessary, further comprise a conductive material and/or a binder.

The current collector, the active material, the conductive material and the binder of the negative electrode may include those commonly used in lithium-sulfur batteries, and the present disclosure is not limited to a particular type.

The separator is disposed between the negative electrode and the positive electrode in the electrode assembly. The separator may separate the negative electrode from the positive electrode and provide movement channels of lithium ions, and may include, without limitation, any type of separator commonly used in lithium secondary batteries.

The electrolyte may include any type of electrolyte available in lithium-sulfur batteries, for example, an organic liquid electrolyte, an inorganic liquid electrolyte, a solid polymer electrolyte, a gel polymer electrolyte, a solid inorganic electrolyte and a molten inorganic electrolyte, but is not limited thereto.

Specifically, the electrolyte may comprise an organic solvent and a lithium salt.

The organic solvent may comprise an ether-based solvent to improve charge/discharge performance of the battery. As a nonaqueous solvent, the ether-based solvent may include at least one of cyclic ether (for example, 1,3-dioxolane, tetrahydrofuran, tetrohydropyran, etc.), a linear ether compound (for example, 1,2 dimethoxyethane, etc.) or low viscosity fluorinated ether (for example, 1H,1H,2′H,3H-decafluorodipropyl ether, difluoromethyl 2,2,2-trifluoroethyl ether, 1,2,2,2-tetrafluoroethyl trifluoromethyl ether, 1,1,2,3,3,3-hexafluoropropyl difluoromethyl ether, 1H,1H,2′H,3H-decafluorodipropyl ether, pentafluoroethyl 2,2,2-trifluoroethyl ether, 1H,1H,2′H-perfluorodipropyl ether).

In an embodiment of the present disclosure, the organic solvent may comprise a mixture of 2-methylfuran and dimethoxyethane, and for example, the mixture of 2-methylfuran and dimethoxyethane at a volume ratio (v/v) of 1:9 to 5:5, but is not limited thereto.

The lithium salt may include, without limitation, any compound that provides lithium ions used in lithium secondary batteries. Specifically, the lithium salt may include LiPF₆, LiClO₄, LiAsF₆, LiBF₄, LiSbF₆, LiAlO₄, LiAlCl₄, LiCF₃SO₃, LiC₄F₉SO₃, LiN(C₂F₅SO₃)₂, LiN(C₂F₅SO₂)₂, LiN(CF₃SO₂)₂, LiCl, LiI or LiB(C₂O₄)₂. The concentration of the lithium salt may be in a range between 0.1 and 5.0M, and preferably 0.1 and 3.0M. When the concentration of the lithium salt is included in the above-described range, the electrolyte may have proper conductivity and viscosity and exhibit outstanding electrolyte performance, thereby effectively transporting lithium ions.

In addition to the above-described constituent substances of the electrolyte, the electrolyte may further comprise an additive to improve the life characteristics of the battery, prevent the capacity fading of the battery and improve the discharge capacity of the battery. For example, the additive may at least one of LiNO₃, a haloalkylene carbonate-based compound such as difluoro ethylene carbonate, pyridine, triethylphosphite, triethanolamine, cyclic ether, ethylene diamine, n-glyme, hexamethylphosphorous triamide, nitrobenzene derivatives, sulfur, a quinone imine dye, N-substituted oxazolidinone, N,N-substituted imidazolidine, ethylene glycol dialkyl ether, an ammonium salt, pyrrole, 2-methoxy ethanol or aluminum trichloride, but is not limited thereto. The additive may be included in an amount of 0.1 to 10 wt %, and preferably 0.1 to 5 wt % based on the total weight of the electrolyte.

Meanwhile, in an embodiment of the present disclosure, in the lithium-sulfur battery of the present disclosure, a ratio (El/S) of the total weight of the electrolyte to the total weight of sulfur (S) in the positive electrode may be preferably, for example, 3.5 g/g or less, for example, 3.3 g/g or less, 3.2 g/g or less, or 3.0 g/g or less. Additionally, in the lithium-sulfur battery, the ratio (El/S) of the total weight of the electrolyte to the total weight of sulfur (S) in the positive electrode may be 2.0 to 3.0 g/g/, for example, 2.3 g/g. Using the sulfur-carbon composite according to the present disclosure, it may be possible to realize the lithium-sulfur battery having the above-described range of El/S ratios, thereby improving energy density. However, the lithium-sulfur battery using the sulfur-carbon composite may have higher El/S ratios than the above-described range, and the present disclosure is not limited thereto.

The lithium-sulfur battery is not limited to a particular shape and may come in various shapes, for example, cylindrical, stack and coin shapes.

Additionally, the present disclosure provides a battery module including the lithium-sulfur battery as a unit battery. The battery module may be used as a source of power for medium- and large-scale devices requiring high temperature stability, long cycle life characteristics and high-capacity characteristics.

According to an embodiment of the present disclosure, the lithium-sulfur battery using the above-described positive electrode may have the discharge capacity per weight of sulfur (S) of 1,000 mAh/gs or more, further 1,100 mAh/gs, but the present disclosure is not limited thereto.

According to an embodiment of the present disclosure, the lithium-sulfur battery using the above-described positive electrode may have the energy density of 350 Wh/kg or more, but the present disclosure is not limited thereto. Specifically, the energy density of the lithium-sulfur battery may be 400 Wh/kg or more or 430 Wh/kg or more, and for example, the energy density of the lithium-sulfur battery may be 350 Wh/kg to 500 Wh/kg or 430 Wh/kg to 480 Wh/kg, but the higher energy density of the lithium-sulfur battery, the better performance of the battery, and thus the upper limit of the energy density is not particularly limited.

In an embodiment of the present disclosure, the lithium-sulfur battery may be used in small devices such as mobile phones as well as medium- and large-scale devices, and examples of the medium- and large-scale device may include power tools; electric cars including electric vehicles (EV), hybrid electric vehicles (HEV), plug-in hybrid electric vehicles (PHEV); electric two-wheeled vehicles including E-bikes, E-scooters; electric golf carts; energy storage systems that work using power produced by an electric motor, but is not limited thereto.

Hereinafter, the present disclosure will be described in more detail through examples, but the following examples are provided by way of illustration, and the scope of the present disclosure is not limited thereto.

### <Manufacture of Lithium-Sulfur Battery>

### Example 1

### Preparation of Porous Carbon Material

Agglomerates of multi-walled carbon nanotubes (Cnano, MWCNT, tap density 0.14 g/cm³, particle shape uniformity 1.52) were prepared. Subsequently, the agglomerates were milled at 18,000 rpm (angular velocity of 94.2 rad/s) using a centrifugal mill (Retsch, ZM-200), and allowed to pass through a sieve having the mesh size of 80 μm to prepare a shape modified porous carbon material.

The tap density of the modified porous carbon material was 0.07 g/cm³, and the measured particle shape uniformity was 1.07.

In this instance, the tap density was measured after tapping the vessel containing the porous carbon material 1,000 times, and the particle shape uniformity was obtained by calculating the ratio of the average diameter of the circumscribed circle to the average diameter of the circumscribed circle of 5 particles through the SEM image (FIG. 4B) of the porous carbon material. (Measurement 1: 1.01, Measurement 2: 1.06, Measurement 3:1.02, Measurement 4: 1.18, Measurement 5: 1.07).

### Manufacture of Sulfur-Carbon Composite

The shape modified porous carbon material obtained as described above and sulfur (S₈) were uniformly mixed at a weight ratio of 30:70 (CNT:S₈). Subsequently, thermal treatment was performed in an oven of 155° C. for 30 minutes to load sulfur onto the porous carbon material to manufacture a sulfur-carbon composite.

### Manufacture of Positive Electrode

The sulfur-carbon composite obtained as described above and polyacrylic acid as a binder polymer were added to water and mixed together to prepare a positive electrode slurry. In this instance, a weight ratio of the sulfur-carbon composite and the binder polymer was 96:4. The solids content in the slurry was 27 wt %.

The slurry was coated on an aluminum foil (thickness: 20 μm) using a Mathis coater and dried at 50° C. for 24 hours, followed by rolling to manufacture a positive electrode. The porosity of the manufactured positive electrode active material layer was 83 vol % and the loading amount of the positive electrode active material was 3.1 mg/cm². In this instance, the porosity was calculated as a percent of a value obtained by subtracting the density (apparent density) of the manufactured positive electrode active material layer from the true density of the constituent materials of the positive electrode active material layer and dividing by the true density.

Porosity (vol %)=[(true density−apparent density)/true density]×100

### Manufacture of Lithium-Sulfur Battery

For a negative electrode, a 45 μm thick lithium metal foil was prepared, and for an electrolyte, a mixed solution of 3 wt % of LiNO₃ and 0.75M of LiFSI was dissolved in a mixed organic solvent of 2-methylfuran and dimethoxyethane at a volume ratio of 3:7.

The positive electrode and the negative electrode manufactured and prepared as described above were placed with a polyethylene separator having the thickness of 16 μm and porosity of 46 vol % interposed between, and the electrolyte was injected 2.3 times larger than the weight of sulfur (S) in the sulfur-carbon composite used for the positive electrode to manufacture a lithium-sulfur battery. (El/S=2.3 g/g)

### Example 2

A lithium-sulfur battery was manufactured by the same method as Example 1 except the weight ratio of the porous carbon material and sulfur was changed to 25:75 (CNT:S₈) when manufacturing the sulfur-carbon composite. In this instance, the porosity of the manufactured positive electrode was 82 vol % and the loading amount of the positive electrode active material was 3.1 mg/cm².

### Comparative Example 1

### Preparation of Porous Carbon Material

Agglomerates of multi-walled carbon nanotubes (Cnano, MWCNT, tap density 0.14 g/cm³, particle shape uniformity 1.52) were prepared. Subsequently, the agglomerates were jet-milled to prepare carbon nanotubes agglomerates having the tap density of 0.1 g/cm³ and the particle shape uniformity of 1.44.

### Manufacture of Sulfur-Carbon Composite

The porous carbon material obtained as described above and sulfur (S₈) were uniformly mixed at a weight ratio of 30:70 (CNT:S₈). Subsequently, thermal treatment was performed in an oven of 155° C. for 30 minutes to load sulfur onto the porous carbon material to manufacture a sulfur-carbon composite.

### Manufacture of Positive Electrode and the Battery

A lithium-sulfur battery was manufactured by the same method as Example 1 except that the sulfur-carbon composite manufactured as described above was used. In this instance, the porosity of the manufactured positive electrode active material layer was 79 vol % and the loading amount of the positive electrode active material was 3.1 mg/cm².

### Comparative Example 2

A lithium-sulfur battery was manufactured by the same method as Comparative Example 1 except that the weight ratio of the porous carbon material and sulfur was changed to 25:75 (CNT:S₈) when manufacturing the sulfur-carbon composite. In this instance, the porosity of the manufactured positive electrode active material layer was 78 vol % and the loading amount of the positive electrode active material was 3.1 mg/cm².

### Comparative Example 3

A lithium-sulfur battery was manufactured by the same method as Comparative Example 1 except that the weight ratio of the porous carbon material and sulfur was changed to 35:65 (CNT:S₈) when manufacturing the sulfur-carbon composite. In this instance, the porosity of the manufactured positive electrode active material layer was 80 vol % and the loading amount of the positive electrode active material was 3.1 mg/cm².

### Comparative Example 4

### Preparation of Porous Carbon Material

Carbon nanotubes agglomerates having the tap density of 0.2/cm³ and the particle shape uniformity of 1.44 were prepared without preprocessing (grinding). FIG. 4A shows an SEM image of the porous carbon material, and the particle shape uniformity was calculated as the value of [average diameter of the circumscribed circle (major axis)/average diameter of the inscribed circle (minor axis)] of 5 particles on the image. (Measurement 1: 2.06, Measurement 2: 1.26, Measurement 3: 1.37, Measurement 4: 1.36, Measurement 5: 1.16)

### Manufacture of Sulfur-Carbon Composite

The porous carbon material obtained as described above and sulfur (S₈) were uniformly mixed at a weight ratio of 25:75 (CNT:S₈). Subsequently, thermal treatment was performed in an oven of 155° C. for 30 minutes to load sulfur onto the porous carbon material to manufacture a sulfur-carbon composite.

### Manufacture of Positive Electrode and Battery

Subsequently, a lithium-sulfur battery was manufactured by the same method as Comparative Example 1 except that the sulfur-carbon composite manufactured as described above was used. In this instance, the porosity of the manufactured positive electrode was 77 vol %, and the loading amount of the positive electrode active material was 3.1 mg/cm².

### <Evaluation of Physical Properties of Lithium-Sulfur Battery>

The characteristics of the lithium-sulfur battery prepared above are summarized in TABLEs 1 and 2 below.

### Tap Density

According to the ASTM B527 standard method, after putting the porous carbon material used in the manufacture of the sulfur-carbon composite in a test vessel and tapping 1,000 times using a tapping device, the mass (Mass, M) (g) of the porous carbon material per the volume (Vomune, V) (cm³) are measured to obtain the tap density.

Tap density (TD)=[M/V]

### Particle Shape Uniformity

After obtaining a 1,000-magnification SEM image (S-4800, Hitachi High-Technologies Corporation) of the porous carbon material used in the manufacture of the sulfur-carbon composite above, the long and short axes of 5 sulfur-carbon composites on the SEM image were measured. And then, the particle shape uniformity was calculated. At this time, the long axis is equal to the diameter of the circumscribed circle of the particle, and the short axis is equal to the diameter of the inscribed circle of the particle.

Particle shape uniformity=[(an average diameter of the circumscribed circle of particles)/(an average diameter of the inscribed circle of the particles)]

### Sulfur (S₈) Content in the Positive Electrode Active Material Layer

The mass of sulfur (S₈) with respect to the total weight of the positive electrode active material layer was calculated from the mass of sulfur (S₈) used to prepare the sulfur-carbon composite and the mass of the sulfur-carbon composite used to prepare the positive electrode active material layer.

### Porosity

For the positive electrode prepared above, it was calculated as a percentage of the value obtained by subtracting the density (apparent density) of the positive electrode active material layer excluding the current collector from the real density of the materials constituting the positive electrode active material layer and dividing it by the true density.

Porosity(vol %)=[(true density−apparent density)/true density]×100

### The Ratio of the Thickness of the Positive Electrode Active Material Layer to the Carbon Weight Per Unit Area

The ratio based on immediately after manufacture and the ratio based on the battery during operation as the battery was repeatedly charged and discharged were measured.

First, for a fresh cell immediately after manufacture, the thickness of the positive electrode was measured using a thickness meter (Mitutoyo Co.), and the thickness of the positive electrode active material layer was measured by subtracting the thickness of the current collector from the measured thickness. In addition, the carbon weight (mg/cm²) per unit area (1 cm²) of the positive electrode active material layer was measured by calculating the carbon weight in the positive electrode active material layer from the composition of the positive electrode used in the manufacturing step and dividing by the active material loading amount. At this time, the calculated value was cross-verified by measuring the carbon weight according to the following method. After removing the current collector from the positive electrode and then conducting ICP-OES (Inductively Coupled Plasma Optical Emission Spectrometry) analysis on the positive electrode active material layer using an elemental analyzer, the total carbon weight in the positive electrode active material layer was obtained. Then, the total carbon weight was divided by the area (cm²) to obtain the carbon weight (mg/cm²) per unit area (1 cm²) of the active material layer.

Next, the thickness of the positive electrode active material layer in a fully charged (SOC 100%) state in a cycle in which the thickness of the positive electrode active material layer represents the minimum thickness during operation maintaining a capacity of 90% or more compared to the initial capacity for the battery. Then, the ratio of the carbon weight (mg/cm²) per unit area (1 cm²) to the thickness of the positive electrode active material layer was calculated.

TABLE 1

| | Porous carbon material | | Positive electrode | |
|---|---|---|---|---|
| | | Particle shape | active material layer | |
| | Tap | uniformity | Sulfur (S₈) | |
| | density | (long axis/ | content | Porosity |
| | (g/cm³) | short axis) | (wt %) | (vol %) |
| Example 1 | 0.07 | 1.07 | 67.2 | 83 |
| Example 2 | 0.07 | 1.07 | 72 | 82 |
| Comparative | 0.1 | 1.44 | 67.2 | 79 |
| example 1 | | | | |
| Comparative | 0.1 | 1.44 | 72 | 78 |
| example 2 | | | | |
| Comparative | 0.1 | 1.44 | 62.2 | 80 |
| example 3 | | | | |
| Comparative | 0.2 | 1.44 | 72 | 77 |
| example 4 | | | | |

TABLE 2

| Ratio of thickness to amount of | | |
|---|---|---|
| carbon per unit area (1 cm²) in | | |
| the positive electrode active | Fresh | Operating |
| material layer (μm/mg) | cell | cell (SOC 100) |
| Example 1 | 95 | 83 |
| Example 2 | 119 | 98 |
| Comparative example 1 | 86 | 76 |
| Comparative example 2 | 95 | 78 |
| Comparative example 3 | 88 | 79 |
| Comparative example 4 | 86 | 69 |

### <Specific Capacity Evaluation of Lithium-Sulfur Battery>

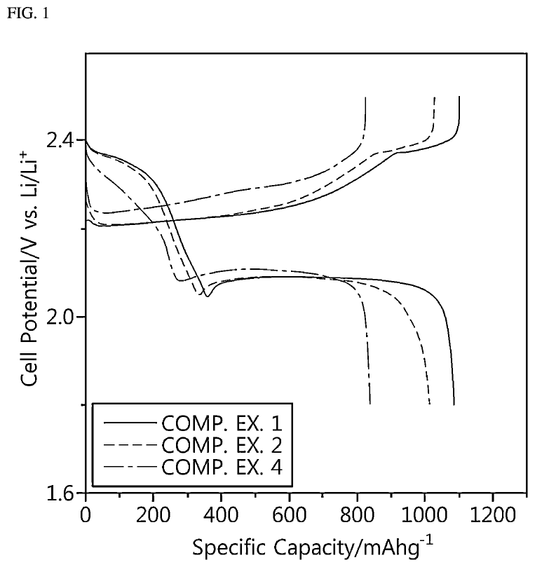

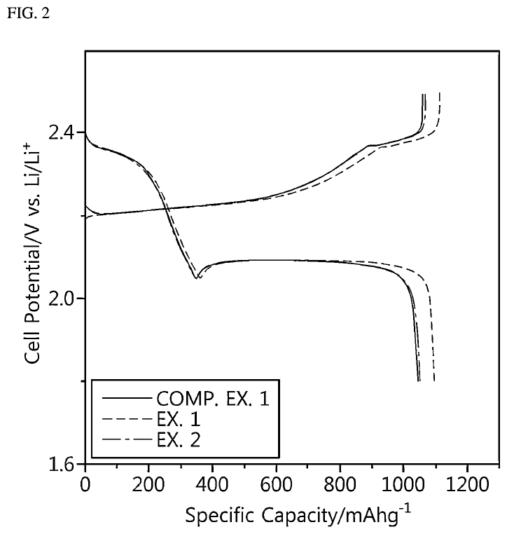

FIG. 1 is a performance evaluation graph of the lithium-sulfur batteries according to Comparative Examples 1, 2 and 4, and FIG. 2 is a performance evaluation graph of the lithium-sulfur batteries according to Examples 1 and 2 and Comparative Example 1.

Each lithium-sulfur battery manufactured in Examples and Comparative Examples was discharged at 0.1 C (C-rate) in CC mode (Constant Current mode) at 25° C. until 1.8V and charged with 0.1 C constant current until 2.5V, and then the discharge capacity was measured. The discharge capacity was measured as the discharge capacity (Specific capacity, mAh/g (s)) per sulfur (S) content in the positive electrode.

Referring to FIG. 1, it can be seen that in the lithium-sulfur battery using the porous carbon material having high tap density and low particle shape uniformity as conventionally, when the sulfur content increases, reactivity reduces and discharge capacity decreases (Comparative Examples 1 and 2). Additionally, it can be seen that as the density of the porous carbon material increases, reactivity reduces and discharge capacity decreases (Comparative Examples 1 and 4).

Referring to FIG. 2, it can be seen that the lithium-sulfur battery using the porous carbon material having low tap density and high particle shape uniformity through shape modification had improved reactivity compared to the lithium-sulfur battery using the same sulfur content but the porous carbon material having high tap density and low particle shape uniformity (Example 1 and Comparative Example 1). Additionally, it can be seen that when the surface modified porous carbon material is used, in case that sulfur loading increases, reactivity is maintained (Examples 1 and 2).

### <Energy Density Comparison>

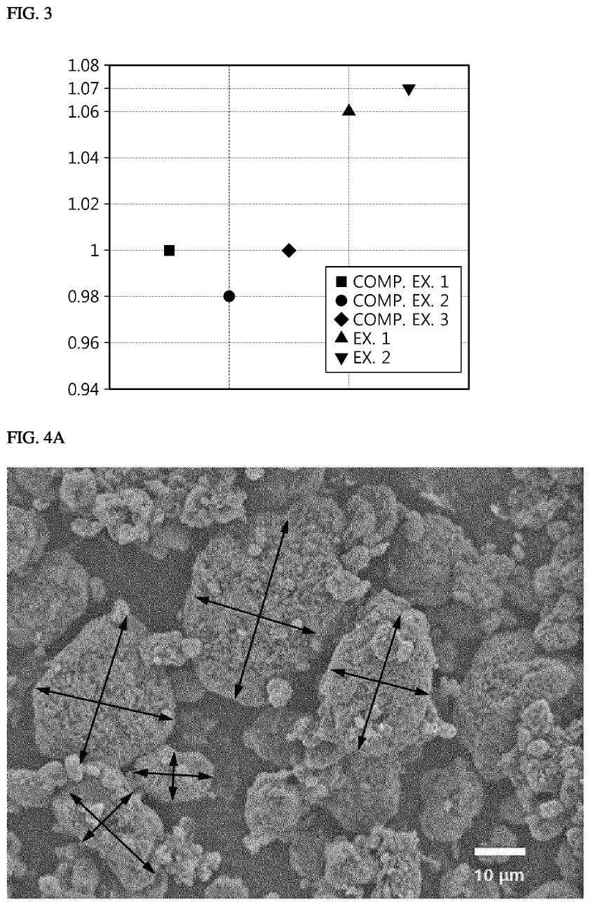

The energy density was calculated by measuring the capacity of the lithium-sulfur batteries according to Examples 1 to 2 and Comparative Examples 1 to 3, multiplying the measured capacity by voltage and dividing by the weight of each lithium-sulfur battery, and its results are shown in the following TABLE 3 and FIG. 3.

FIG. 3 is a graph showing the relative energy density of the lithium-sulfur batteries according to Examples 1 to 2 and Comparative Examples 1 to 3 to the energy density of Comparative Example 1.

TABLE 3

| | Energy density (Wh/kg) |
|---|---|
| Comparative example 1 | 425 |
| Comparative example 2 | 418 |
| Comparative example 3 | 425 |
| Example 1 | 446 |
| Example 2 | 458 |

In the case of Comparative Examples 1 to 3, i.e., the lithium-sulfur batteries using the porous carbon material having high tap density and low particle shape uniformity as conventionally, it was confirmed that as the sulfur content increases, reactivity reduces and discharge capacity decreases, resulting in low energy density (Comparative Examples 1 and 2). It was confirmed that Comparative Example 3 had high reactivity due to low sulfur loading, but low energy density due to the small amount of the positive electrode active material.

On the other hand, it was confirmed that the lithium-sulfur battery according to Example 1 had the improved reactivity and discharge capacity and consequential increased energy density, and Example 2 had higher sulfur content than Example 1 but did not reduce in discharge capacity, and thus had an increase in energy density.

Although the present disclosure has been hereinabove described with regard to a limited number of embodiments and drawings, the present disclosure is not limited thereto, and it is obvious to those skilled in the art that various changes and modifications may be made thereto within the technical aspect of the present disclosure and the appended claims and equivalents thereof.

What is claimed is:

1. A positive electrode, comprising:
a current collector; and
a positive electrode active material layer on at least one surface of the current collector,
wherein the positive electrode active material layer comprises a sulfur-carbon composite and a binder polymer,
wherein the sulfur-carbon composite comprises a porous carbon material and a sulfur-based material disposed on at least a portion of an inside of pores and a surface of the porous carbon material, and
wherein a ratio of a thickness of the positive electrode active material layer (μm) to an amount of carbon per unit area (1 cm²) in the positive electrode active material layer (mg) is 80 to 130 μm/mg.

2. The positive electrode according to claim 1, wherein an amount of sulfur (S) is 65 wt % or more and less than 100 wt % based on 100 wt % of the positive electrode active material layer.

3. The positive electrode according to claim 1, wherein a porosity of the positive electrode active material layer is 80 vol % or more.

4. The positive electrode active according to claim 1, wherein a tap density of the porous carbon material is 0.09 g/cm³ or less, and
wherein the tap density is measured after tapping a vessel containing the porous carbon material 1000 times.

5. The positive electrode according to claim 1, wherein the porous carbon material has a particle shape uniformity according to Equation 1 of 1.3 or less:
Particle shape uniformity=[an average diameter of a circumscribed circle of particles]/[an average diameter of an inscribed circle of the particles]. [Equation 1]

6. The positive electrode according to claim 1, wherein a sulfur loading amount of the positive electrode is more than 2.9 mgs/cm².

7. The positive electrode according to claim 1, wherein the porous carbon material comprises bundled carbon nanotubes or entangled carbon nanotubes.

8. The positive electrode according to claim 4, wherein the tap density of the porous carbon material is 0.07 g/cm³ or less.

9. The positive electrode according to claim 1, wherein the porous carbon material is a product from which a raw material porous carbon material is centrifugally milled and filtered through a sieve having a mesh size 2.8 to 4 times of a D₅₀ particle size of the porous carbon material.

10. A lithium-sulfur battery, comprising:
the positive electrode according to claim 1;
a negative electrode;
a separator between the positive electrode and the negative electrode; and
an electrolyte.

11. The lithium-sulfur battery according to claim 10, wherein a weight ratio (El/S weight ratio) of the electrolyte and sulfur (S) in the sulfur-carbon composite is 3.5 g/g or less.

12. The lithium-sulfur battery according to claim 10, wherein an energy density of the lithium-sulfur battery is 400 Wh/kg or more.

13. The lithium-sulfur battery according to claim 10, wherein the thickness of the positive electrode active material layer (μm) and the amount of carbon per unit area) in the positive electrode active material layer (mg) are values measured when a state of charge (SOC) of the lithium-sulfur battery is 97% to 100%.

14. The lithium-sulfur battery according to claim 10, wherein the thickness of the positive electrode active material layer (μm) and the amount of carbon per unit area in the positive electrode active material layer (mg) are values measured after at least one discharge of the lithium-sulfur battery.

15. The lithium-sulfur battery according to claim 10, wherein an amount of the sulfur (S) is 65 wt % or more and less than 100 wt % based on 100 wt % of the positive electrode active material layer.

16. The lithium-sulfur battery according to claim 10, wherein a porosity of the positive electrode active material layer is 80 vol % or more.

17. The lithium-sulfur battery according to claim 10, wherein a tap density of the porous carbon material is 0.09 g/cm³ or less, and
wherein the tap density is measured after tapping a vessel containing the porous carbon material 1000 times.

18. The lithium-sulfur battery according to claim 10, wherein the porous carbon material has a particle shape uniformity according to Equation 1 of 1.3 or less:
Particle shape uniformity=[an average diameter of a circumscribed circle of particles]/[an average diameter of an inscribed circle of the particles]. [Equation 1]

19. The lithium-sulfur battery according to claim 10, wherein a sulfur loading amount of the positive electrode is more than 2.9 mgs/cm².

20. The lithium-sulfur battery according to claim 10, wherein the porous carbon material comprises bundled carbon nanotubes or entangled carbon nanotubes.
